(19) United States
(12) Patent Application Publication
(10) Pub. No.: US 2007/0137950 A1
(43) Pub. Date: Jun. 21, 2007

(54) Brake shoe return mechanism

(75) Inventors: Yuan-Hsiang Jen, Dasi Township (TW); Chun-Chin Wang, Dasi Township (TW)

Correspondence Address: TROXELL LAW OFFICE PLLC, SUITE 1404, 5205 LEESBURG PIKE, FALLS CHURCH, VA, 22041, US

(73) Assignee: Heng Tong Machinery Co., Ltd.

(21) Appl. No.: 11/304,752

(22) Filed: Dec. 16, 2005

(51) Int. Cl. F16D 55/22

(52) U.S. Cl. 188/72.3

(57) ABSTRACT

A brake shoe return mechanism applied in a bike or motor vehicle has a gap disposed each on both sides of a brake lining of each brake shoe, and a lug is disposed at each arm extending from a return spring to both sides of the brake lining to penetrate into the gap for securing the spring in place to avoid mal-position of the return spring and ensuring normal operation of the brake.

### BACKGROUND OF THE INVENTION

(a) Field of the Invention

The present invention is related to a disk brake applied in a bike or motor vehicle, and more particularly, to an improved mechanism allows the brake shoe to return to its status of not contacting a brake disk.

(b) Description of the Prior Art

As illustrated in FIG. 1 of the accompanying drawings, a disk brake mounted to a front wheel of a bike or motor vehicle is essentially comprised of a brake disk 10, a brake pad 20, a brake cylinder 30, a brake return spring 40 and a bolt 50. The brake disk 10 is concentrically positioned and operating synchronously with the wheel. By taking advantage the fact that the liquid is prevented from compression and the Pascal's Law (states that pressure applied to a confined fluid at any point is transmitted undiminished through out the fluid in all directions and acts upon all the parts of the confined vessel at right angles to its interior surfaces and equally upon equal areas), the brake shoe 20 is hydraulically driven to clamp on the brake disk 10 to produce friction between the brake shoe and the disk or drum to stop the wheel.

In the entire disk braking mechanism, the cylinder 30 is provided to secure the brake shoe 20 in position, and connected through hydraulic piping to a master cylinder for a brake pull rod to hydraulically push brake oil filled inside the hydraulic cylinder. As illustrated in FIG. 2, the each piston 31 in the cylinder 30 is actuated hydraulically to push the brake shoe 20 to contact the brake disk 10 for applying brake.

Once the impetus from the pushing piston 31 is released, the brake shoe 20 then contacting the brake disk 10 must immediately return to its original status of clearing away from the brake disk 10 for the wheel to resume normal turning status. To achieve the purpose, a magnetic to attract the brake shoe may be disposed on the piston; or alternatively, the brake return spring 40 is disposed to the brake shoe between both sides of the brake disk 10. As illustrated in FIG. 3, when the hydraulic impetus is released, the brake shoe spring 40 with its inherited elasticity immediately pushes the brake shoe 20 then contacting the brake disk 10 to where it is separated from the brake disk 10 to allow the wheel resuming its normal turning.

As illustrated in FIG. 4, on each of both sides of the brake shoe spring 40 respectively contacting the brake shoe 20 extends an arm 41 to make sure that the elasticity from the brake shoe spring 40 is consistently distributed over the brake shoe 20. However, lacking in supplementary positioning means and repeated application of brake will result in mal-positioning between the brake shoe spring 40 and the brake shoe 20 to affect the normal operation of the brake system. Therefore, an improvement of the prior art as illustrated in FIG. 5 has been introduced into the market. In the prior art, multiple mounting holes 42, 22, 32 are respectively disposed on the brake shoe spring 40, the brake shoe 20, and the cylinder 30, and then penetrated through by the bolt 50 to limit the displacement of the brake shoe spring 40 to prevent its mal-position. However, the prior art not only increase the production cost but also renders the assembly and disassembly too much complicate.

### SUMMARY OF THE INVENTION

The primary purpose of the present invention is to provide a brake shoe return mechanism to correct the flaws found with the prior art. To achieve the purpose, each of both edges of the lining of the brake shoe is disposed with a gap; and a lug penetrating into the gap is provided on each arm extending from the brake shoe spring to both sides of the brake lining to firmly secure the brake shoe spring in position to avoid mal-position for ensuring the normal operation of the brake system.

### BRIEF DESCRIPTION OF THE DRAWINGS

FIG. 1 is a schematic view showing adaptation of a general disk brake system.

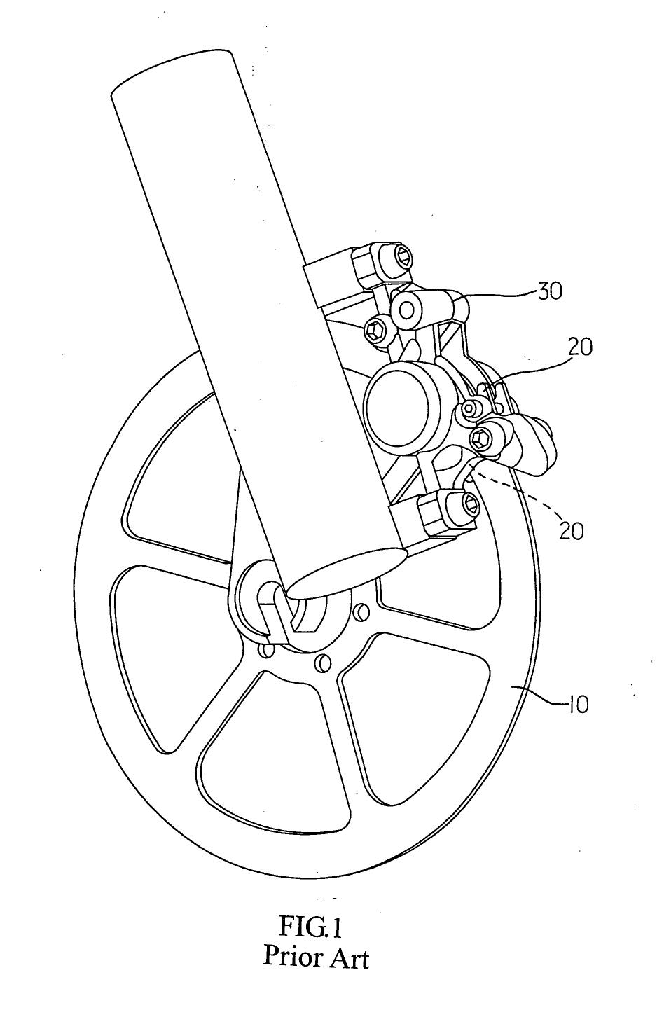

FIG. 2 is a sectional view showing that a brake shoe and a brake disk of the general disk brake system holding flushed against each other.

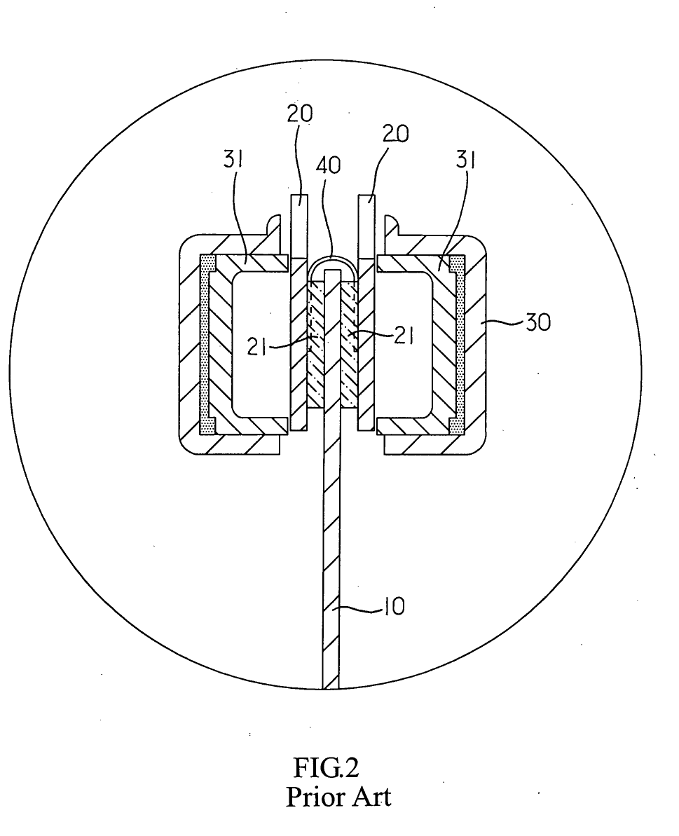

FIG. 3 is a sectional view showing that the brake shoe and the brake disk of the general disk brake system separating from each other.

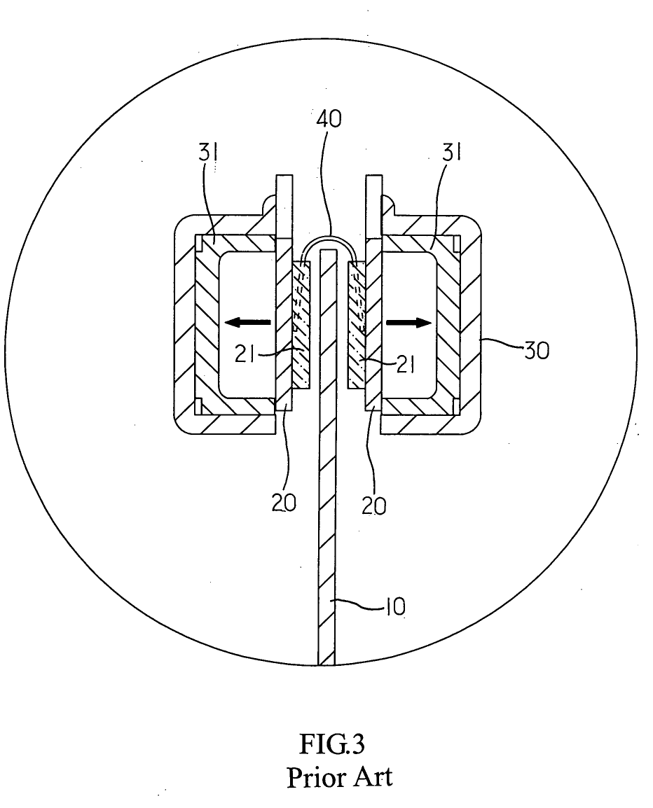

FIG. 4 is a layout of a brake shoe spring and brake shoe assembly of a brake shoe return mechanism of the prior art.

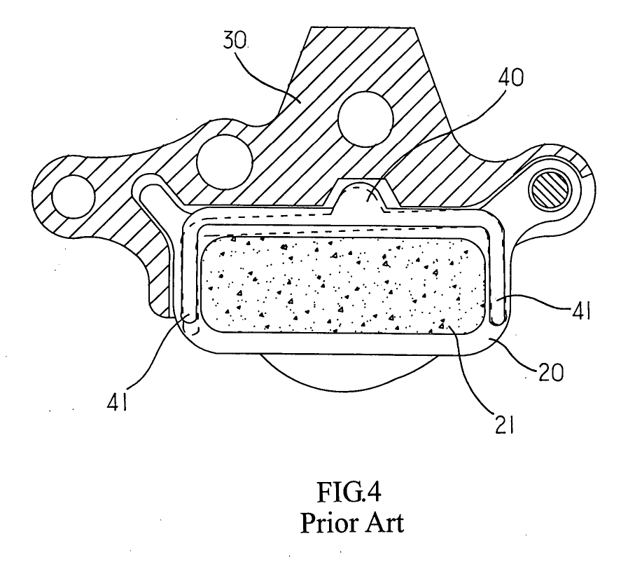

FIG. 5 is an exploded view of another brake shoe return mechanism of the prior art.

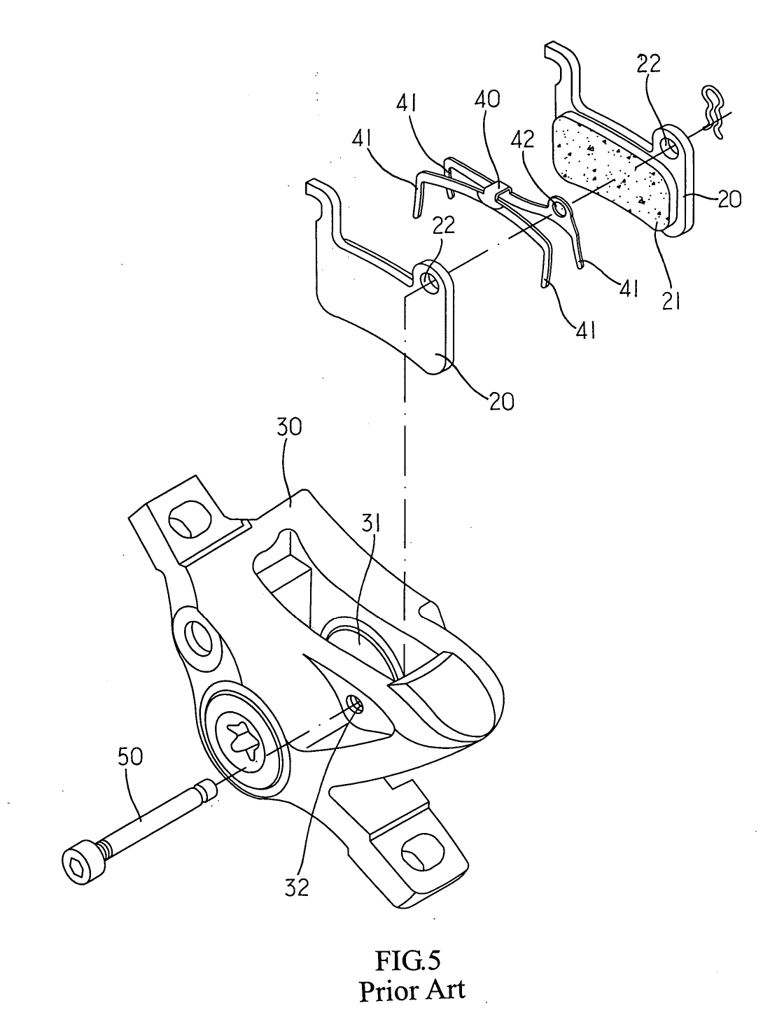

FIG. 6 is an exploded view of a preferred embodiment of the present invention.

FIG. 7 is a perspective view of a brake shoe spring and a brake shoe assembly of the preferred embodiment of the present invention.

### DETAILED DESCRIPTION OF THE PREFERRED EMBODIMENTS

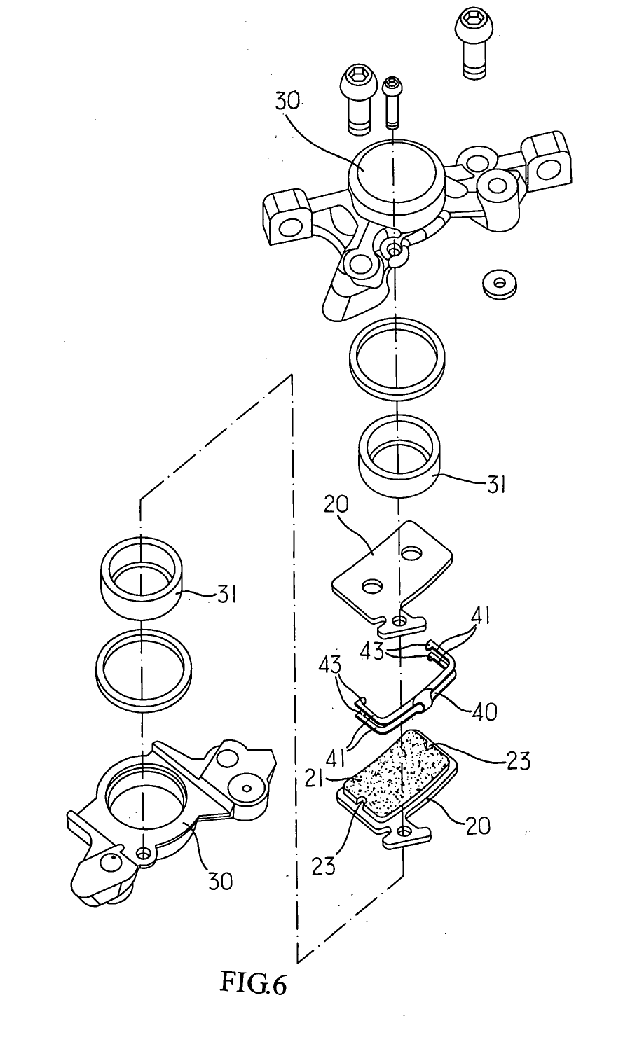

A brake shoe return mechanism of the present invention adapted to a bike or a motor vehicle is related to an improved construction that allows return of a brake shoe to its status not contacting a brake disk in a disk brake system. As illustrated in FIG. 6, a preferred embodiment of the present invention is comprised of a clamping cylinder 30 disposed on the edge of a brake disk (not illustrated) as the subject matter of the mechanism for the assembly of related members.

The cylinder 30 has its both sides to be respectively penetrated by the brake disk is disposed of a hydraulic passage, a piston 31 and a brake shoe 20. Through the connection of the hydraulic piping, brake oil from the master cylinder enters into the clamping cylinder 30 to push the piston 31, and in turn the piston 31 drives the brake shoe 20 to press flushed against the brake disk for creating friction between a brake lining 21 of the brake shoe and the brake disk to apply brake.

A brake shoe spring 40 is disposed between two brake shoes 20. On each side of the brake shoe spring 40 that contacts the brake shoe extends two arms 41 to press against both sides of the brake lining 21 to ensure that the elasticity from the brake shoe spring 40 is consistently distributed on the brake shoe 20 so that when the hydraulic pressure exercised by brake oil is released, the brake shoe spring 40 will immediately push the brake shoe contacting the brake disk 10 back to where it is disengaged from the brake disk to allow the wheel resume normal turning.

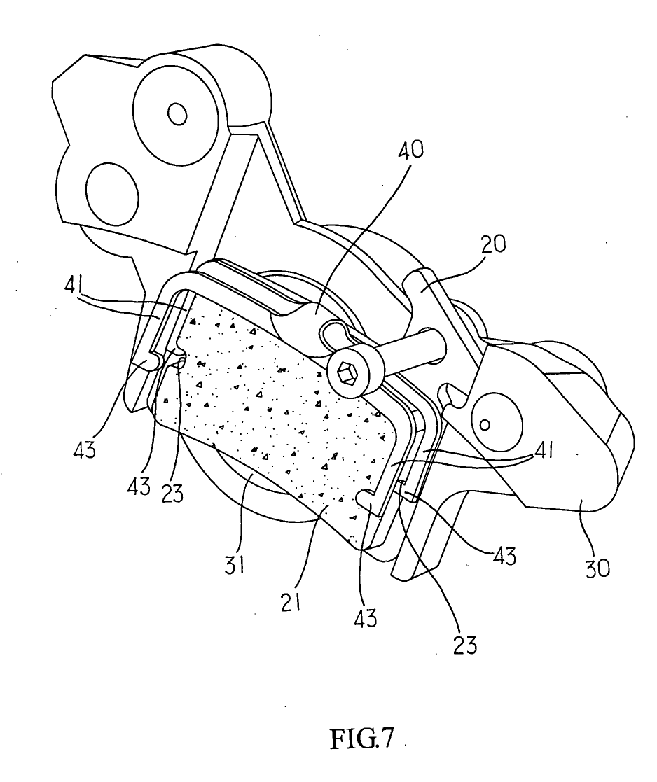

Now referring to FIG. 7, a gap 23 is each disposed on the edge of both sides of the brake lining 21 of each brake shoe 20, and a lug 43 to penetrate into the gap 23 is disposed on each arm 41 extending to each of both sides of the braking line from the brake show spring 40. The lug 43 is formed by directly bending the tail of the extension arm. By locking the lug 43 into the gap 23 ensures of firmly securing the brake shoe spring 40 in position to make sure of normal operation of the brake system by preventing the brake shoe spring from mal-position. With the present invention, the brake system in general does not require any other supplementary member in preventing the brake shoe spring from mal-position to lower production cost and allow easy assembly and disassembly of the of the members.

The prevent invention provides an improved construction of a brake shoe return mechanism for a bike or motor vehicle, and the application for a utility patent is duly filed accordingly. However, it is to be noted that the preferred embodiments disclosed in the specification and the accompanying drawings are not limiting the present invention; and that any construction, installation, or characteristics that is same or similar to that of the present invention should fall within the scope of the purposes and claims of the present invention.

I claim:

1. A brake shoe return mechanism is comprised of a spring between two brake shoes of a clamping cylinder; two arms are disposed on the side of the spring that contacts the brake shoe to press against both sides of a brake lining; a gap is disposed on each brake shoe at the edge of each of both sides of the brake lining; and a lug to penetrate into the gap is disposed to the arm extended from the spring to prevent mal-position of the spring.

2. The brake shoe return mechanism of claim 1, wherein, each lug is formed by directly bending the tail of the extension arm.
